(19) United States
(12) Patent Application Publication
(10) Pub. No.: US 2018/0292693 A1
(43) Pub. Date: Oct. 11, 2018

(54) A DISPLAY PANEL AND AN ARRAY SUBSTRATE THEREOF

(71) Applicant: WUHAN CHINA STAR OPTOELECTRONICS TECHNOLOGY CO., LTD., Wuhan, Hubei (CN)

(72) Inventors: Yu-cheng TSAI, Shenzhen, Guangdong (CN); Changwen MA, Shenzhen, Guangdong (CN); Zhou ZHANG, Shenzhen, Guangdong (CN); Pan XU, Shenzhen, Guangdong (CN)

(73) Assignee: WUHAN CHINA STAR OPTOELECTRONICS TECHNOLOGY CO., LTD., Wuhan, Hubei (CN)

(21) Appl. No.: 15/328,433

(22) PCT Filed: Dec. 29, 2016
(86) PCT No.: PCT/CN2016/113180

§ 371 Date: Jan. 23, 2017

(30) Foreign Application Priority Data
Dec. 27, 2016 (CN) 201611229786.X

(51) Int. Cl. G02F 1/1368; G02F 1/1362; G02F 1/1343; G02F 1/1333; G02F 1/133; G02F 1/1335; G06F 3/044; G06F 3/041

(52) U.S. Cl. CPC G02F 1/1368; G02F 1/136286; G02F 1/13439; G02F 1/13338; G02F 1/13306; G06F 2203/04103; G06F 3/044; G06F 3/0412; G06F 3/0416; G02F 2201/123; G02F 1/133514

(57) ABSTRACT

The disclosure is related to liquid crystal display technology field, and in particular to an array substrate. By manufacturing a touch circuit and a source/drain on the same layer, the touch circuit receives a touch signal from a drive circuit and transmits to a first transparent conductive layer. The array substrate of present disclosure is self-capacitive touch sensor with In-Cell touch function. Compare to prior arts, a manufacturing process of a metal layer and an isolated layer is omitted in the disclosure so that steps of manufacturing process can be simplified, raw to materials can be saved, and further manufacturing period of a TFT substrate can be reduced and manufacturing cost reduction of a TFT substrate can be achieved. The TFT substrate in the disclosure has In-Cell touch function, simplified structure, and low manufacturing cost.

### TECHNICAL FIELD

The disclosure is related to a liquid crystal display technology field and, in specifically, to an array substrate.

### DESCRIPTION OF RELATED ART

With development of display technology, touch display panel is widely acceptable and used, for example touch display panel is used in smart phone, tablet computer and so on. Touch display panel combines touch panel with liquid crystal display by In-cell touch technology so that liquid crystal display panel is capable of displaying and sensing touch input, and widely used in all kinds of consumer electronics products such as mobile phones, TV, PDA, digital camera, laptop, personal computer, and so on. And then touch display panel becomes the mainstream in the display device.

Liquid crystal display is usually composed of a color filter substrate, an array substrate, a liquid crystal between the color filter substrate and the array substrate and a sealant, wherein the process thereof generally comprises Frond-End array process (film, yellow light, etching and stripping), Middle cell process (fitting TFT substrate and color filter substrate), and Back-End module assembly process (laminating driver IC and printed circuit board). Wherein the frond-End array process is mainly to form TFT substrate so as to control the movement of liquid crystal molecules; middle cell process is mainly to add liquid crystal between TFT substrate and color filter substrate; back-End module is mainly to integrate the lamination of driver IC and printed circuit board, and then drive the movement of liquid crystal molecules to display.

According to different structures, touch display panel can be categorized into On-Cell on which touch electrodes are covered, In-Cell inside which touch electrodes are and Add-On Type. Wherein the In-Cell Type has evolved into the main direction of touch technology with advantages of including low cost, super thin and thin frame, and In-Cell Type is mainly used in high-end products.

As illustrated in FIG. 1, a TFT substrate of a present touch display panel applying in In-Cell type, comprising a substrate 100, a shielding layer 200, a buffer layer 300, a polycrystalline silicon layer 400, a gate insulated layer 500, a gate 520, a first interlayer insulated layer 600, a source/drain 610, a flat layer 700, a first transparent conductive layer 810, a touch electrode (M3 layer) 820, a second interlayer insulated layer (IL) 850, a passivation layer 900, and a pixel electrode 950. Wherein the touch electrode and the first transparent conductive layer 810 are disposed on the same layer, and the second interlayer insulated layer 850 and the passivation layer 900 are between the touch electrode and the first transparent conductive layer 810 so that period of manufacturing process of TFT substrate is longer, thickness increasing and higher manufacturing cost.

### BRIEF SUMMARY

In order to solve the above problems in the present technology, an array substrate is provide in the disclosure for getting simpler structure.

The array substrate comprises a substrate, a plurality of data lines and gate lines, and a plurality of sub-pixel units surrounded by both the data lines and the gate lines; wherein the sub-pixel units comprising:

a pixel electrode;

a thin film transistor comprising a gate and a source/drain, wherein the gate is electrically connected to the gate lines, and the source/drain is electrically connected to the data lines and the pixel electrode respectively;

a transparent electrode layer disposed between the thin film transistor and the pixel electrode;

a touch circuit is disposed on a layer on which the source/drain is, wherein the touch circuit is electrically connected to the transparent electrode layer through a first via.

Wherein the touch circuit is insulated to the source/drain.

Wherein the transparent electrode layer is divided into several mutual insulation of self-capacitance electrodes, and the self-capacitance electrodes are electrically connected to the drive circuit of the array substrate through the touch circuit;

the drive circuit is used to provide the self-capacitance electrode with a touch signal for being touch electrode;

the drive circuit is used to provide the self-capacitance electrode with a common voltage for being common electrode.

Wherein the drive circuit is electrically connected to the data lines and the gate lines for providing the gate lines with a scan signal and for providing the data lines with a data signal.

Wherein the area disposing the touch circuit is corresponding to a photoresist vacant area inside the sub-pixel units.

Wherein the area disposing the touch circuit is corresponding to a photoresist vacant area inside blue sub-pixel units.

Wherein the area disposing the touch circuit is corresponding to a photoresist vacant area inside white sub-pixel units.

A display panel, which comprises a color filter substrate and an array substrate disposed corresponding to each other, and a liquid crystal layer disposed between the color filter substrate and the array substrate, is further provided;

the array substrate comprises a substrate, a plurality of data lines and gate lines, and a plurality of sub-pixel units surrounded by the data lines and gate lines; the sub-pixel units comprising:

a pixel electrode;

a thin film transistor comprising a gate and a source/drain, wherein the gate is electrically connected to the gate lines, and the source/drain is electrically connected to the data lines and the pixel electrode respectively;

a transparent electrode layer disposing between the thin film transistor and the pixel electrode;

a touch circuit is disposed on a layer on which the source/drain is, wherein the touch circuit is electrically connected to the transparent electrode layer through a first via.

Wherein the touch circuit is insulated to the source/drain.

Wherein the transparent electrode layer is divided into several mutual insulation of self-capacitance electrodes, and the self-capacitance electrodes are electrically connected to the drive circuit of the array substrate through the touch circuit;

the drive circuit is used to provide the self-capacitance electrode with a touch signal for being touch electrode;

the drive circuit is used to provide the self-capacitance electrode with a common voltage for being common electrode.

Wherein the drive circuit is electrically connected to the data lines and the gate lines for providing the gate lines with a scan signal and for providing the data lines with a data signal.

Wherein the area disposing the touch circuit is corresponding to a photoresist vacant area inside the sub-pixel units.

### Advantage Effects

A structure of the array substrate is provided in the disclosure without applying a M3 layer and an IL layer herein, and the function of the M3 layer is substitute for the touch electrodes on a layer on which the source/drain is so that the structure is more downsizing. Therefore, the structure can be simplified hereto. According to the simplified structure, steps of manufacturing process can be decreased, raw materials can be saved, and cost of production can be reduced by reducing manufacturing the M3 layer and the IL layer during manufacturing of the array substrate; furthermore, qualified product rate increases and economic benefits increases at the same time.

### BRIEF DESCRIPTION OF THE DRAWINGS

The following description in conjunction with the accompanying drawings, the above and other aspects, features and advantages of the embodiments of the present invention will become more apparent from the accompanying drawings in which:

FIG. 1 is a schematic structural view of a array substrate according to prior art;

FIG. 2 is a cross-sectional view of a display panel according to an embodiment 1 of the disclosure;

FIG. 3 is a top view of a array substrate according to the embodiment 1 of the disclosure;

FIG. 4 is a schematic view of a transparent conductive layer of the array substrate according to the embodiment 1 of the disclosure;

FIG. 5 is a schematic view of a touch circuit of the array substrate according to the embodiment 1 of the disclosure;

FIG. 6 is a touch circuit diagram of the array substrate according to the embodiment 1 of the disclosure;

FIG. 7 is a schematic view of a touch circuit of a array substrate according to an embodiment 2 of the disclosure;

FIG. 8 is a touch circuit diagram of the array substrate according to the embodiment 2 of the disclosure;

FIG. 9 is a schematic view of a touch circuit of a array substrate according to an embodiment 3 of the disclosure;

FIG. 10 is a touch circuit diagram of the array substrate according to the embodiment 3 of the disclosure.

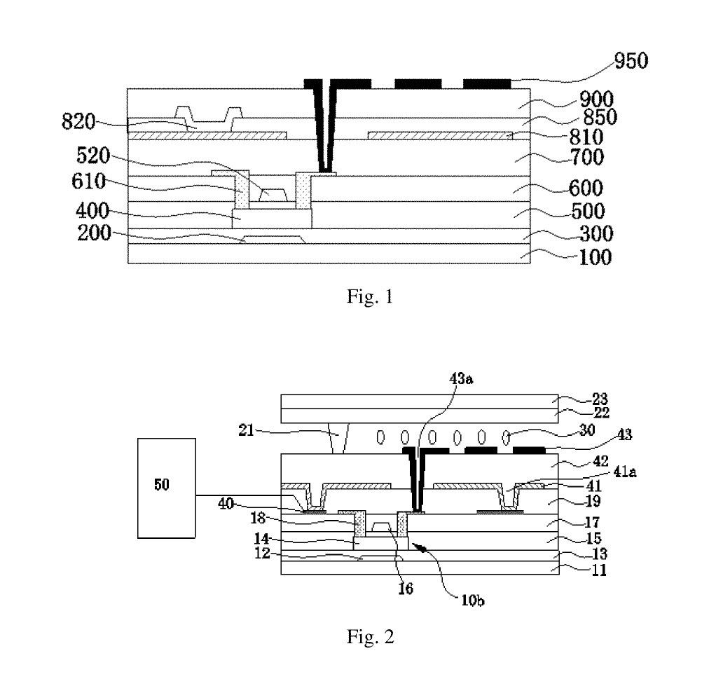

### DETAILED DESCRIPTION

Hereinafter, detailed embodiments will be described with reference to the accompanying drawings of the present invention. However, in many different forms and embodiments of the present invention, and the invention should not be construed as limited to the specific embodiments set forth herein. In contrast, these embodiments are provided to explain the principles of the invention and its practical application so that others skilled in the art to understand the invention for various embodiments and various modifications suited to the particular intended application.

### Embodiment 1

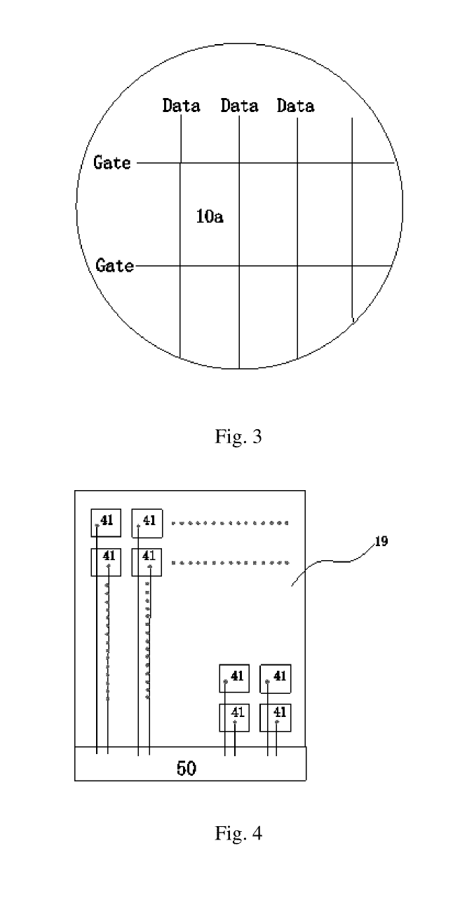

As illustrated in FIG. 2 and FIG. 3, a display panel is provided in this embodiment, wherein the display panel comprises a color filter substrate 20 arranged oppositely to an array substrate 10 and a liquid crystal layer 30 disposed between the color filter substrate 20 and the array substrate 10.

Wherein the color filter substrate 20 comprises a supporting element 21, a color filter 22 and glass substrate 23 away from liquid crystal molecules 30 in sequence. There are at least red photoresist (R) , green photoresist (G) and blue photoresist (B) disposed on the color filter 22, and some of display applying RGBW technology further comprises white photoresist (W).

Wherein the array substrate 10 comprises a substrate 11, a plurality of data lines and gate lines 16, and a plurality of sub-pixel units 10a surrounded by the data lines and the gate lines disposed on the substrate 11.

As illustrated in FIG. 2, every sub-pixel units 10a comprises a pixel electrode 43, a thin film transistor 10b, and a transparent electrode layer 41 disposed between the thin film transistor 10b and the pixel electrode 43. A touch display panel in the disclosure further comprises a touch circuit 40.

The thin film transistor 10b comprises a gate 16 and a source/drain 18, wherein the gate 16 is electrically connected to the gate lines, and the source/drain 18 is electrically connected to the data lines and the pixel electrode 10a respectively;

a touch circuit 40 is disposed on the same layer on which the source/drain 18 is disposed, and the touch circuit 40 is electrically connected to the transparent electrode layer 41 through a first via 41a.

Specifically, the array substrate 10 of the embodiment comprises a substrate 11, a shielding metal layer 12 disposed on the substrate 11, a buffer layer 13 disposed between the shielding metal layer 12 and the substrate 11; a polycrystalline silicon layer 14 is disposed on the buffer layer 13; a gate insulated layer 15 is disposed between the polycrystalline silicon layer 14 and the buffer layer 13; gate lines 16 are disposed on the gate insulated layer 15 and a interlayer insulated layer 17 is disposed on the gate lines 16 and the gate insulated layer 15.

The source/drain 18 and the touch circuit 40 are disposed on the interlayer insulated layer 17, and the source/drain 18 is disposed on the polycrystalline silicon layer 14 by penetrating the interlayer insulated layer 17 and being through the gate insulated layer 15. Meanwhile, the touch circuit 40 insulating to the source/drain 18 is disposed on the interlayer insulated layer 17. During the real manufacturing process, preparation of materials of the source/drain 18 and those of the touch circuit 40 are the same; the applicable materials, for example, are metal molybdenum, aluminum or copper with different role and function.

A flat layer 19 is disposed on the source/drain 18, the touch circuit 40 and the interlayer insulated layer 17; the transparent electrode layer 41 is disposed on the flat layer 19. The transparent electrode layer 41 penetrates the flat layer 19 through a first via 41a to connecting with the touch circuit 40.

As illustrated in FIG. 4, the transparent electrode layer 41 is divided into several mutual insulations of self-capacitance electrodes 41b, and the self-capacitance electrodes 41b are electrically connected to the drive circuit 50 of the array substrate 10 through the touch circuit 40.

The drive circuit is used to provide the self-capacitance electrode with a touch signal for being touch electrode; the drive circuit is used to provide the self-capacitance electrode with a common voltage for being common electrode. Therefore, the transparent electrode layer 41 assumes as the role of touch electrode and common electrode respectively when in touch section and in display section.

A passivation layer 42 is disposed on a transparent electrode layer 41 and the flat layer 19; the transparent electrode layer 41 is disposed on the flat layer 19. The pixel electrode layer 43 (also can be a second transparent conductive layer) is disposed on the passivation layer 42, and the pixel electrode layer 43 penetrates the passivation layer 42 and the flat layer 19 through a second via 43a to connecting with the drain of the source/drain 18. The pixel electrode layer 43 contacts with liquid crystal molecules 30.

In the embodiment, a M3 layer and an IL layer are removed from the structure of the array substrate 10, and the function of the M3 layer is substitute for the touch circuit 40 so that the structure of the array substrate is further simplified.

As illustrated in FIG. 3, there are various types in layout of the touch circuit 40. Generally, to achieving the best performance of a color filter, elements or layouts disposed on the array substrate 10 are corresponding to areas which are photoresist vacant areas between two neighboring sub-pixel units and without photoresists. Therefore, the touch circuit 40, the data lines and the source/drain 18 of the embodiment are disposed on areas corresponding to the photoresist vacant areas of the red, green and blue sub-pixel units. The array substrate of the disclosure belongs to self-capacitive touch sensor, and the schematic thereof is illustrated in FIG. 4.

### Embodiment 2

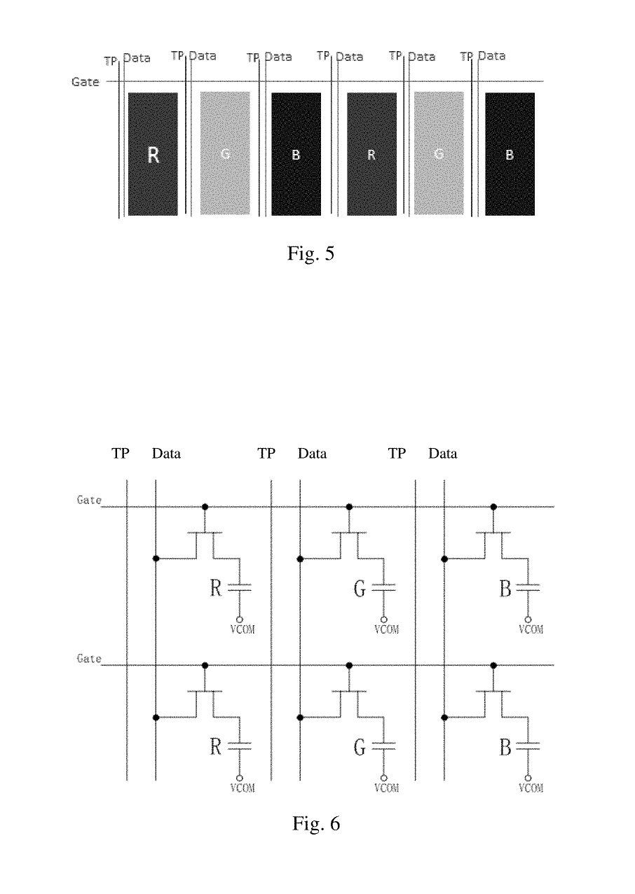

The difference between the present embodiment and embodiment 1 is that locations of the touch circuit 40 and the source/drain 18 are adjusted. According to the touch circuit 40 and the source/drain 18 in the present disclosure are disposed on the same layer, the touch circuit 40 cannot overlap data lines and forms photoresist areas occupying two sides of sub-pixel units inside the narrow photoresist vacant areas easily. The photoresist property is affected or the aperture ratio of the array substrate is decreased. Therefore, the touch circuit 40 is only disposed inside blue sub-pixel units under the premise of maintaining the same aperture ratio, and as illustrated in FIG. 5, the touch circuit 40 is disposed the photoresist vacant areas of the blue sub-pixel units. The reason for choosing blue sub-pixel is that the photoresist has minimum contribution on brightness; therefore, if shading part of lighting areas is not avoidable, the brightness of the display panel has little effect.

An array substrate of present embodiment belongs to self-capacitive touch sensor, and the circuit diagram thereof is as illustrated in FIG. 6.

### Embodiment 3

The present embodiment is to a display panel applying RGBW technology (further comprising white photoresists in color filter substrate). Compare to embodiment 2, the difference is as shown in FIG. 7, the touch circuit 40 is only disposed inside the photoresist vacant area of the white photoresists; similarly, even shading part of lighting areas is not avoidable, there is no negative effect for the whole quality of the display panel.

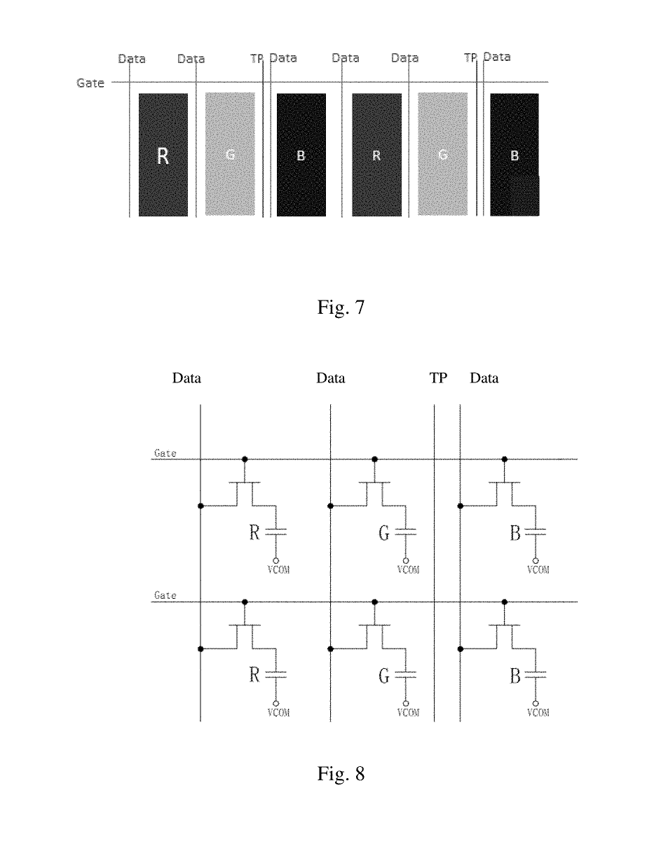

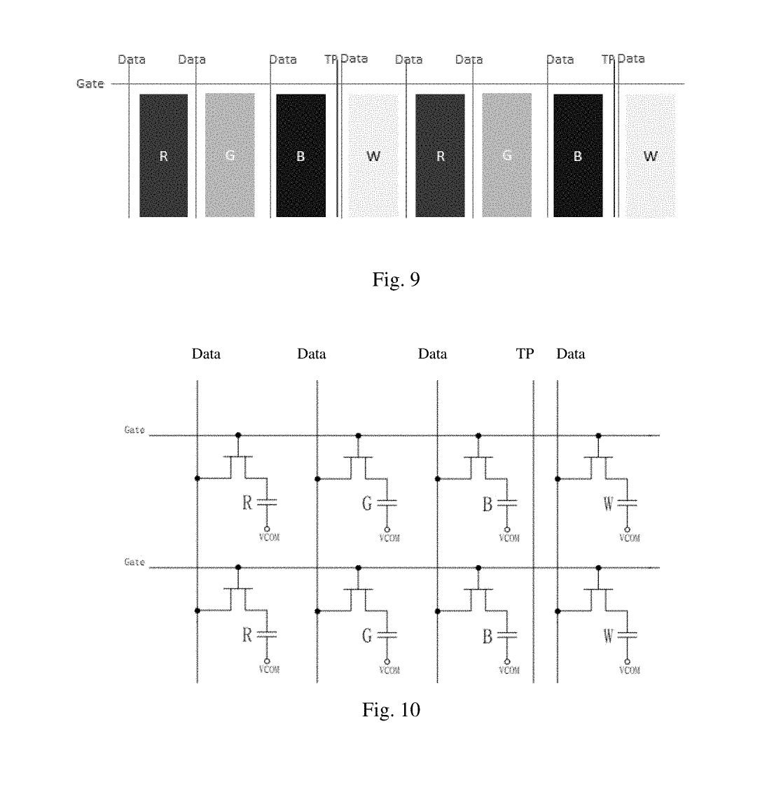

An array substrate in the present embodiment belongs to self-capacitive touch sensor, and the circuit diagram thereof is illustrated in FIG. 8.

Compare to prior arts, a manufacturing process of a metal layer and an isolated layer is omitted in the disclosure so that steps of manufacturing process can be simplified, raw materials can be saved, and further manufacturing period of a TFT substrate can be reduced and manufacturing cost reduction of a TFT substrate can be achieved. The TFT substrate in the disclosure has In-Cell touch function, simplified structure, and low manufacturing cost.

It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

What is claimed is:

1. An array substrate, comprising a substrate, a plurality of data lines and gate lines, and a plurality of sub-pixel units surrounded by the data lines and the gate lines; wherein the sub-pixel units comprise:
a pixel electrode;
a thin film transistor comprising a gate and a source/drain, wherein the gate is electrically connected to the gate lines, and the source/drain is electrically connected to the data lines and the pixel electrode respectively;
a transparent electrode layer disposing between the thin film transistor and the pixel electrode;
a touch circuit disposing on a layer on which the source/drain is disposed, wherein the touch circuit is electrically connected to the transparent electrode layer through a first via. is 2. The array substrate according to claim 1, wherein the touch circuit is insulated to the source/drain.

3. The array substrate according to claim 1, wherein the transparent electrode layer is divided into several mutual insulation self-capacitance electrodes, and the self-capacitance electrodes are electrically connected to the drive circuit of the array substrate through the touch circuit;
the drive circuit is used to provide the self-capacitance electrode with a touch signal for being touch electrode;
the drive circuit is used to provide the self-capacitance electrode with a common voltage for being common electrode.

4. The array substrate according to claim 3, wherein the drive circuit is electrically connected to the data lines and the gate lines for providing the gate lines with a scan signal and for providing the data lines with a data signal.

5. The array substrate according to claim 1, wherein the area disposing the touch circuit is corresponding to a photoresist vacant area inside the sub-pixel units.

6. The array substrate according to claim 1, wherein the area disposing the touch circuit is corresponding to a photoresist vacant area inside blue sub-pixel units.

7. The array substrate according to claim 1, wherein the area disposing the touch circuit is corresponding to a photoresist vacant area inside white sub-pixel units.

8. A display panel, comprising a color filter substrate and an array substrate disposed corresponding to each other, and a liquid crystal layer disposed between the color filter substrate and the array substrate; wherein
the array substrate comprises a substrate, a plurality of data lines and gate lines, and a plurality of sub-pixel units surrounded by the data lines and gate lines; the is sub-pixel units comprising:
a pixel electrode;
a thin film transistor comprising a gate and a source/drain, wherein the gate is electrically connected to the gate lines, and the source/drain is electrically connected to the data lines and the pixel electrode respectively;
a transparent electrode layer disposing between the thin film transistor and the pixel electrode;
a touch circuit is disposed on a layer on which the source/drain is, wherein the touch circuit is electrically connected to the transparent electrode layer through a first via.

9. The display panel according to claim 8, wherein the touch circuit is insulated to the source/drain.

10. The display panel according to claim 8, wherein the transparent electrode layer is divided into several mutual insulation of self-capacitance electrodes, and the self-capacitance electrodes are electrically connected to the drive circuit of the array substrate through the touch circuit;
the drive circuit is used to provide the self-capacitance electrode with a touch signal for being touch electrode;
the drive circuit is used to provide the self-capacitance electrode with a common voltage for being common electrode.

11. The display panel according to claim 10, wherein the drive circuit is electrically connected to the data lines and the gate lines for providing the gate lines with a scan signal and for providing the data lines with a data signal.

12. The array substrate according to claim 8, wherein the area disposing the touch circuit is corresponding to a photoresist vacant area inside the sub-pixel units.
